(19) United States
(12) Patent Application Publication
(10) Pub. No.: US 2022/0276814 A1
(43) Pub. Date: Sep. 1, 2022

(54) CONTROL APPARATUS, CONTROL METHOD, AND NON-TRANSITORY COMPUTER-READABLE STORAGE MEDIUM STORING PROGRAM

(71) Applicant: SEIKO EPSON CORPORATION, TOKYO (JP)

(72) Inventor: Yasuaki MIYADOME, Sapporo-shi Atsubetsu-ku (JP)

(21) Appl. No.: 17/653,008

(22) Filed: Mar. 1, 2022

(30) Foreign Application Priority Data
Mar. 1, 2021 (JP) 2021-031833

(51) Int. Cl. G06F 3/12; G06K 15/10; B41J 2/21

(52) U.S. Cl. CPC G06F 3/1219; G06F 3/1256; G06F 3/1239; G06K 15/102; G06F 3/1207; B41J 2/2103

(57) ABSTRACT

A control apparatus that controls a printing apparatus having one or more nozzles associated with a color material to eject, includes: a receiver that receives ejection permission/prohibition specification information specifying, for each of the one or more nozzles, whether the nozzle is permitted to eject or prohibited from ejecting the color material and a display controller that displays, on a display unit, based on the ejection permission/prohibition specification information received by the receiver and print job information including image information indicating an image to be printed on a print medium, information indicating permission or prohibition of ejection about at least one of one or more types of color materials to be used for printing in accordance with the print job information.

The present application is based on, and claims priority from JP Application Serial Number 2021-031833, filed Mar. 1, 2021, the disclosure of which is hereby incorporated by reference herein in its entirety.

### BACKGROUND

### 1. Technical Field

The present disclosure relates to a control apparatus, a control method, and a non-transitory computer-readable storage medium storing a program.

### 2. Related Art

Studies and developments have been done relating to control of printing apparatuses.

In this respect, as a method for controlling a printing apparatus, there is known a control method in which when the type of a print medium to be used to print an image and the type of ink to be used to print the image do not match, a warning is displayed, indicating that the type of the print medium and the type of the ink do not match (see JP-A-2016-106324).

There is also known a printing apparatus capable of identifying an ink that is lowering printing quality by specifying, for each of a plurality of inks usable to print an image, whether the ink is permitted to be ejected or prohibited from being ejected. In such a printing apparatus, an image may end up being printed while an ink expected to be used to print the image is prohibited from being ejected. However, with the control method such as the one described in JP-A-2016-106324, the printing apparatus cannot display a warning before printing an image, indicating that the ink expected to be used to print the image is prohibited from being ejected. For this reason, in this printing apparatus, there are cases where an image ends up being printed while some of one or more inks to be used to print an image is prohibited from being ejected. As a result, the printing apparatus may not only consume ink wastefully, but also waste a large number of sheets. This is because when an image is printed while an ink expected to be used to print the image is prohibited from being ejected, the printing apparatus does not eject that ink.

### SUMMARY

According to an aspect of the present disclosure, a control apparatus that controls a printing apparatus having one or more nozzles associated with a color material to eject, includes a receiver that receives ejection permission/prohibition specification information specifying, for each of the one or more nozzles, whether the nozzle is permitted to eject or prohibited from ejecting the color material and a display controller that displays, on a display unit, based on the ejection permission/prohibition specification information received by the receiver and print job information including image information indicating an image to be printed on a print medium, information indicating permission or prohibition of ejection about at least one of one or more types of color materials to be used for printing in accordance with the print job information.

According to an aspect of the present disclosure, a control method for controlling a printing apparatus having one or more nozzles associated with a color material to eject, includes a receiving step of receiving ejection permission/prohibition specification information specifying, for each of the one or more nozzles, whether the nozzle is permitted to eject or prohibited from ejecting the color material and a displaying step of displaying, on a display unit, based on the ejection permission/prohibition specification information received in the receiving step and print job information including image information indicating an image to be printed on a print medium, information indicating permission or prohibition of ejection about at least one of one or more types of color materials to be used for printing in accordance with the print job information.

According to an aspect of the present disclosure, a non-transitory computer-readable storage medium stores a program for causing a computer that controls a printing apparatus having one or more nozzles associated with a color material to eject to execute processing including a receiving step of receiving ejection permission/prohibition specification information specifying, for each of the one or more nozzles, whether the nozzle is permitted to eject or prohibited from ejecting the color material and a displaying step of displaying, on a display unit, based on the ejection permission/prohibition specification information received in the receiving step and print job information including image information indicating an image to be printed on a print medium, information indicating permission or prohibition of ejection about at least one of one or more types of color materials to be used for printing in accordance with the print job information.

### BRIEF DESCRIPTION OF THE DRAWINGS

FIG. 1 is a schematic diagram showing an example configuration of a printing apparatus.

FIG. 2 is a diagram showing an example hardware configuration of a control apparatus.

FIG. 3 is a diagram showing an example configuration of print job information.

FIG. 4 is a diagram showing an example functional configuration of the control apparatus.

FIG. 5 is a diagram showing an example of ejection permission/prohibition specification information reception image.

FIG. 6 is a diagram showing an example of a first image.

FIG. 7 is a diagram showing an example of the first image with color material ejection permission/prohibition information being displayed in a region.

FIG. 8 is a diagram showing an example print preview image displayed on a display unit when a select operation is performed on an image.

FIG. 9 is an example flowchart of processing performed by the control apparatus to display the color material ejection permission/prohibition information.

FIG. 10 is another example flowchart of processing performed by the control apparatus to display the color material ejection permission/prohibition information.

### DESCRIPTION OF EXEMPLARY EMBODIMENTS

### Embodiment

An embodiment of the present disclosure is described below with reference to the drawings.

### Configuration of the Printing Apparatus

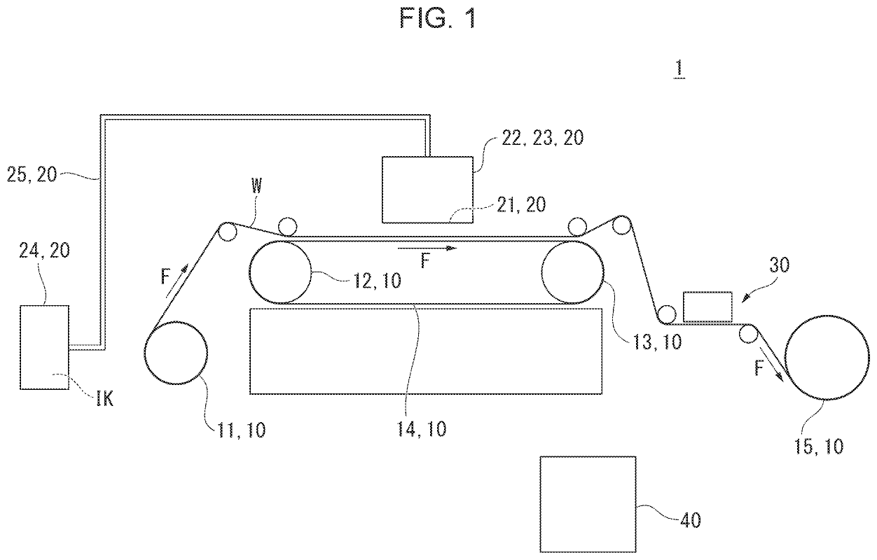

First, taking a printing apparatus 1 as an example, a description is given of the configuration of a printing apparatus according to the embodiment. FIG. 1 is a schematic diagram showing an example configuration of the printing apparatus 1.

The printing apparatus 1 is a textile printer that performs textile printing on a print medium such as fabric by attaching a color material IK onto the print medium. As an example, the following describes a case where the printing apparatus 1 performs textile printing on a print medium W by attaching a color material IK onto the print medium W. The print medium W is, for example, fabric formed of a natural fiber, a synthetic fiber, or the like. In this case, the print medium W is a material to be textile-printed. Note that instead of fabric, the print medium W may be, for example, a sheet for ink jet recording, such as plain paper, high-quality paper, or gloss paper. The color material IK may be ink, toner, or other color materials. As an example, the following describes a case where the color material IK is ink. In other words, in this example, the printing apparatus 1 is an ink jet printing apparatus that forms an image on the print medium W by ejecting the color material IK to the print medium W.

The printing apparatus 1 includes a transport mechanism 10, a print unit 20, a drying unit 30, and a control apparatus 40. The transport mechanism 10 includes an unreeling device 11, a transport roller 12, a transport roller 13, a transport belt 14, and a reeling device 15. The print unit 20 includes a printhead 21, a carriage 22, a carriage driving mechanism 23, a color material container 24, and a color material supply path 25. Note that, to simplify the drawing, FIG. 1 does not show, for example, cables through which the control apparatus 40 is communicatively connected to the transport mechanism 10, the print unit 20, and the drying unit 30. Also, the printing apparatus 1 may be configured to include other members, other devices, and the like in addition to the transport mechanism 10, the print unit 20, the drying unit 30, and the control apparatus 40. Also, the transport mechanism 10 may be configured to include other members, other devices, and the like in addition to the unreeling device 11, the transport roller 12, the transport roller 13, the transport belt 14, and the reeling device 15. Also, the print unit 20 may be configured to include other members, other devices, and the like in addition to the printhead 21, the carriage 22, the carriage driving mechanism 23, the color material container 24, and the color material supply path 25. Also, to simplify the drawing, FIG. 1 shows the carriage 22 and the carriage driving mechanism 23 as one rectangular object. Also, in the printing apparatus 1, the control apparatus 40 may be formed integrally with some or all of the transport mechanism 10, the print unit 20, and the drying unit 30. Also, the printing apparatus 1 may be separate from the control apparatus 40. In this case, the printing apparatus 1 may be configured to have the control apparatus 40 or not to have the control apparatus 40.

The unreeling device 11 is a device that unreels the print medium W which is long and wound into a roll. The unreeling device 11 is located most upstream on the transport path of the print medium W.

The transport roller 12 and the transport roller 13 are a pair of rollers that drive the endless transport belt 14. The transport roller 12 is, for example, a drive roller. In this case, the transport roller 13 is a driven roller. Also, in this case, the transport mechanism 10 further includes a motor (not shown) for driving the transport roller 12. Note that the transport roller 12 may be a driven roller. In this case, the transport roller 13 is a drive roller. Also, in this case, the transport mechanism 10 further includes a motor (not shown) for driving the transport roller 13.

The transport belt 14 is a glue belt on which an adhesive layer being adhesive on its outer peripheral surface is formed. The transport belt 14 adhesively holds the print medium W unreeled from the unreeling device 11 onto the adhesive layer of the transport belt 14. Then, as the transport roller 12 and the transport roller 13 rotate, the transport belt 14 transports the adhesively-held print medium W in a transport direction F shown in FIG. 1. After that, the transport belt 14 supports the print medium W at a position where the print medium W faces the printhead 21.

The reeling device 15 is located downstream on the transport path for the print medium W. The reeling device 15 reels in the print medium W printed by the printhead 21 to a reel in the reeling device 15.

The drying unit 30 is disposed upstream of the reeling device 15. The drying unit 30 is located between the position where the print medium W is printed by the printhead 21 and the reeling device 15. The drying unit 30 dries the color material IK attached to the print medium W. The drying unit 30 has, for example, a chamber to house the print medium W and a heater disposed inside the chamber. The drying unit 30 uses heat from the heater to dry the undried color material IK on the print medium W.

Note that the transport mechanism 10 may be configured to include at least one of a tensioner and an intermediate transport roller as a member located between the unreeling device 11 and the transport roller 12 and between the transport roller 13 and the reeling device 15. The tensioner is a member that applies tension by, for example, pressing the print medium W by use of a roller while the print medium W is transported. The intermediate transport roller is, for example, a pair of rollers that pinch the print medium W. The intermediate transport roller transports the print medium W with the paired rollers rotating while pinching the print medium W.

The printhead 21 ejects the color material IK. The printhead 21 is mounted to the carriage 22. The printhead 21, along with the carriage 22, reciprocates above the print medium W in a main scan direction of the printhead 21. The mechanism that causes the carriage 22 to perform this reciprocation is the carriage driving mechanism 23. The carriage driving mechanism 23 is a mechanism that causes the carriage 22 to reciprocate in the main scan direction. The carriage driving mechanism 23 includes, for example, a motor as a drive source, a guide member that guides the movement of the carriage 22, gears and links that transmit the power from the motor to the carriage 22, and the like.

The printhead 21 is coupled to the color material container 24 via the color material supply path 25. The color material container 24 is, for example, an ink cartridge in which to retain the color material IK to be ejected by the printhead 21. Note that instead of the ink cartridge, the color material container 24 may be a different member capable of retaining the color material IK, such as a bottle.

The printhead 21 can eject a plurality of types of color materials IK. The type of a color material IK is classified by the color, chemical composition, chemical property, and the like of the color material IK. Note that the chemical property means an alkaline property, an acidic property, or the like. Thus, the printing apparatus 1 is capable of color printing using a plurality of types of color materials IK. As an example, the following describes a case where the type of a color material IK is classified only by the color of the color material. In this case, the type of a color material IK is synonymous with the color of the color material IK. Also, as an example, the following describes a case where the printing apparatus 1 is capable of printing using eight types of color materials IK, namely, black (BK), cyan (C), magenta (M), yellow (Y), blue (BL), gray (GY), white (AC), and orange (OR), as the plurality of types of the color materials IK. In other words, as an example, the following describes a case where the printing apparatus 1 is capable of printing using eight colors of color materials IK, namely, black (BK), cyan (C), magenta (M), yellow (Y), blue (BL), gray (GY), white (AC), and orange (OR), as the plurality of types of the color materials IK. In this case, the printhead 21 is capable of ejecting these eight types of color materials IK. Note that the printing apparatus 1 may be configured to be capable of printing using other types of color materials IK instead of some or all of these eight types of color materials IK. Also, the printing apparatus 1 may be configured to be capable of printing using other types of color materials IK in addition to all of the eight types of color materials IK. The printing apparatus 1 may also be configured to be capable of printing using seven or less types of color material IK. Also, the printing apparatus 1 may be configured to be capable of using a special type such as a metallic color, i.e., the color material IK of a spot color.

The printing apparatus 1 is equipped with the color material containers 24 for the respective types of color materials IK. Specifically, in this example, the printing apparatus 1 is equipped with the color material containers 24 for the following eight types of color materials IK: black (BK), cyan (C), magenta (M), yellow (Y), blue (BL), gray (GY), white (AC), and orange (OR). Each of the color material containers 24 for the respective eight types of color materials IK includes a sensor that detects the remaining amount of the color material IK retained therein. For instance, the color material container 24 that retains the black color material IK includes a sensor that detects the remaining amount of the black color material IK. Also, for instance, the color material container 24 that retains the orange color material IK includes a sensor that detects the remaining amount of the orange color material IK. Such a relation between the color material container 24 and the sensor applies to all the colors other than black and orange as well. A sensor in the color material container 24 retaining the color material IK of a certain color outputs color material remaining amount information indicating the detected remaining amount of the color material IK to the control apparatus 40. For instance, a sensor that detects the remaining amount of the black color material IK outputs color material remaining amount information indicating the remaining amount of the black color material IK to the control apparatus 40. Also, for instance, a sensor that detects the remaining amount of the orange color material IK outputs color material remaining amount information indicating the remaining amount of the orange color material IK to the control apparatus 40.

The printhead 21 includes one or more ejection units that eject the color material IK. As an example, the following describes a case where the printhead 21 includes eight ejection units. As an example, the following describes a case where these eight ejection units are namely a first ejection unit, a second ejection unit, a third ejection unit, a fourth ejection unit, a fifth ejection unit, a sixth ejection unit, a seventh ejection unit, and an eighth ejection unit. Each of these eight ejection units has one or more nozzles that eject the color material IK. As an example, the following describes a case where the eight ejection units each have two nozzles. Each of the nozzles of the eight ejection units is associated with one of the eight types of color materials IK that the printhead 21 is capable of ejecting. Then, each nozzle ejects the color material IK with which the nozzle is associated. As an example, the following describes a case where the first ejection unit has a nozzle associated with the yellow color material IK and a nozzle associated with the orange color material IK. Also, as an example, the following describes a case where the second ejection unit has a nozzle associated with the white color material IK and a nozzle associated with the blue color material IK. As an example, the following describes a case where the third ejection unit has a nozzle associated with the gray color material IK and a nozzle associated with the magenta color material IK. As an example, the following describes a case where the fourth ejection unit has a nozzle associated with the cyan color material IK and a nozzle associated with the black color material IK. As an example, the following describes a case where the fifth ejection unit has a nozzle associated with the black color material IK and a nozzle associated with the cyan color material IK. As an example, the following describes a case where the sixth ejection unit has a nozzle associated with the magenta color material IK and a nozzle associated with the gray color material IK. As an example, the following describes a case where the seventh ejection unit has a nozzle associated with the blue color material IK and a nozzle associated with the white color material IK. As an example, the following describes a case where the eighth ejection unit has a nozzle associated with the orange color material IK and a nozzle associated with the yellow color material IK. Each of these nozzles is coupled, via the color material supply path 25, to the color material container 24 that retains the color material IK with which the nozzle is associated.

By having such eight ejection units, the printhead 21 can perform printing using eight types of color materials IK.

Note that the printhead 21 may be configured to eject a penetrant to the print medium W besides the color material IK. The penetrant is a liquid that promotes penetration of the color material IK attached to the surface of the print medium W into the back surface of the print medium W. In this case, for example, the printing apparatus 1 includes, apart from the color material containers 24, a receptacle for retaining the penetrant, such as a cartridge or a bottle. Then, in this case, the receptacle is coupled to the printhead 21. In this case, the printhead 21 ejects the penetrant to the print medium W at the same time it ejects the color material IK, or ejects the penetrant to the print medium W at a timing different from the ejection of the color material IK.

As described earlier, the carriage 22 reciprocates in the main scan direction, which is a direction intersecting with the transport direction F of the print medium W. In other words, the carriage 22 scans in the main scan direction in a reciprocating manner. As an example, the following describes a case where the main scan direction of the printhead 21 is orthogonal to the transport direction F of the print medium W. Thus, in this example, the carriage 22 reciprocates in the main scan direction orthogonal to the transport direction F. For the convenience of illustration, in the area of the print medium W, the length of a region to which the color materials IK are ejected, which is measured in the transport direction F, is referred to as print length in the following description. Also, for the convenience of illustration, in the area of the print medium W, the length of the region to which the color materials IK are ejected, which is measured in the main scan direction, is referred to as print width in the following description.

The control apparatus 40 performs overall control of the printing apparatus 1. Specifically, the control apparatus 40 controls each of the transport mechanism 10, the print unit 20, and the drying unit 30. Note that in the present embodiment, what is meant by the control apparatus 40 performing certain printing is the control apparatus 40 causing each of the transport mechanism 10, the print unit 20, and the drying unit 30 to perform the printing.

The control apparatus 40 receives one or more pieces of print job information either in response to a user operation or from a different apparatus coupled to the control apparatus 40. The print job information is information including image information indicating an image to be printed by the printing apparatus 1, to-be-used color material information indicating one or more types of color materials IK to be used to print the image indicated by the image information, print width information indicating print width, and print length information indicating print length. Note that the print job information may be configured to include other information in addition to the above information. The print job information may be referred to as print job data. The to-be-used color material information included in certain print job information may be configured to include information indicating one or more types of color materials IK to be used for each raster of the image indicated by the image information included in the certain print job information, or may be configured to include information in a different format indicative of one or more types of color materials IK to be used to print the image indicated by the image information. As an example, the following describes a case where the to-be-used color material information includes information indicative of one or more types of color materials IK to be used for each raster of the image indicated by the image information included in the certain print job information. From among one or more pieces of print job information received, the control apparatus 40 executes one or more pieces of print job information specified by a user as print job information to be executed, thereby performing printing in accordance with each of the specified one or more pieces of print job information. What is meant by printing in accordance with certain print job information is using one or more types of color materials IK indicated by the to-be-used color material information included in the print job information to print the image indicated by the image information included in the print job information onto a region on the area of the print medium W, the region being specified by the print width indicated by the print width information included in the print job information and the print length indicated by the print length information included in the print job information. When the print job information includes an additional piece of information other than the four pieces of information, namely the image information, the to-be-used color material information, the print width information, and the print length information, the printing in accordance with the print job information is performed based also on the additional piece of information. For the convenience of illustration, each of one or more pieces of print job information specified by a user as print job information to be executed from among the one or more pieces of print job information received by the control apparatus 40 is referred to as specified print job information in the following description.

To perform printing in accordance with certain print job information, the control apparatus 40 converts the print job information into an executable command. For the convenience of illustration, the command thus converted is referred to as a print job in the following description. In other words, the control apparatus 40 generates a print job based on print job information and performs the printing based on the print job generated.

Also, for each of one or more pieces of print job information received, the control apparatus 40 can calculate, based on the print job information, the usage amount of each color material IK to be used for printing in accordance with the print job information. More specifically, the control apparatus 40 can calculate the usage amount of each type of color material IK based on the pixel count, the print width, the print length, and the ink dot size of the image. As an example, the following describes a case where the ink dot size is predetermined. Note that the control apparatus 40 may be configured to receive ink dot size information indicative of ink dot size. In this case, the print job information includes the ink dot size information.

The control apparatus 40 also displays an image containing, as a print job information list, a list including one or more pieces of print job information received. Then, via the image thus displayed, the control apparatus 40 receives an operation such as editing, adding, or deleting with respect to the one or more pieces of print job information included in the print job information list. Thus, a user can perform an operation such as editing, adding, or deleting with respect to the one or more pieces of print job information included in the print job information list displayed. The control apparatus 40 also receives, via the image, an operation for specifying specified print job information from among the one or more pieces of print job information included in the print job information list.

The control apparatus 40 also receives, in response to a user operation, association information in which each of the 16 nozzles of the printhead 21 is associated with one of the eight types of color materials IK. With this, the control apparatus 40 can identify the types of color materials IK ejected from the respective 16 nozzles. Note that the control apparatus 40 may receive the association information using any method. The control apparatus 40 may also be configured to have the association information stored therein in advance. Also, the control apparatus 40 may be configured such that each of the 16 nozzles of the printhead 21 is associated with one of the eight types of color materials IK in advance.

Based on the association information received, the control apparatus 40 generates, as an ejection permission/prohibition specification information reception image, an image for receiving ejection permission/prohibition specification information specifying, for each of the 16 nozzles of the printhead 21, whether the nozzle is permitted to eject or prohibited from ejecting the color material IK. The control apparatus 40 displays the ejection permission/prohibition specification information reception image thus generated. Then, via the ejection permission/prohibition specification information reception image displayed, the control apparatus 40 receives the ejection permission/prohibition specification information specifying, for each of the 16 nozzles of the printhead 21, whether the nozzle is permitted to eject or prohibited from ejecting the color material IK. When the ejection permission/prohibition specification information specifies that a certain one of the 16 nozzles is permitted to eject the color material IK, the control apparatus 40 permits this nozzle to eject the color material IK. Thus, in this case, when the printing apparatus 1 prints an image on a print medium, the color material IK is ejected from this nozzle. Meanwhile, when the ejection permission/prohibition specification information specifies that a certain one of the 16 nozzles is prohibited from ejecting the color material IK, the control apparatus 40 prohibits this nozzle from ejecting the color material IK. Thus, in this case, when the printing apparatus 1 prints an image on a print medium, the color material IK is not ejected from this nozzle. For the convenience of illustration, a nozzle among the 16 nozzles which is specified by the ejection permission/prohibition specification information as being permitted to eject the color material IK is referred to as an ejection permitted nozzle in the following description. Also, for the convenience of illustration, a nozzle among the 16 nozzles which is specified by the ejection permission/prohibition specification information as being prohibited from ejecting the color material IK is referred to as an ejection prohibited nozzle in the following description.

The control apparatus 40 also determines, based on the ejection permission/prohibition specification information received and the print job information received, whether a combination of the one or more types of color materials IK indicated by the to-be-used color material information included in the print job information is covered by a combination of the color materials IK ejected from the ejection permitted nozzles among the 16 nozzles. In an example where the to-be-used color material information indicates one type of color material IK, the combination of the color materials IK indicated by the to-be-used color material information includes only one type of color material IK. In another example where the to-be-used color material information indicates three types of color materials IK, the combination of the color materials IK indicated by the to-be-used color material information includes three types of color materials IK. Also, in an example where one of the 16 nozzles is an ejection permitted nozzle, the combination of the color materials IK ejected from the ejection permitted nozzle of the 16 nozzles includes only one type of color material IK. In another example where three of the 16 nozzles are ejection permitted nozzles, when the types of color materials IK associated with these respective three nozzles do not overlap with one another, the combination of the color materials IK ejected from the ejection permitted nozzles among the 16 nozzles includes three types of color materials IK. In yet another example where none of the 16 nozzles is an ejection permitted nozzle, the combination of the color materials IK ejected from the ejection permitted nozzles among the 16 nozzles includes no color material IK. When it is determined that the combination of the one or more types of color materials IK indicated by the to-be-used color material information is not covered by the combination of the color materials IK ejected from the ejection permitted nozzles, the control apparatus 40 displays information indicating permission or prohibition of ejection about at least one of the one or more types of color materials IK to be used for the printing in accordance with the print job information. Thus, the control apparatus 40 can reduce the risk of an image being printed while some of the one or more types of color materials IK to be used to print the image is prohibited from being ejected. For the convenience of illustration, this information is referred to as color material ejection permission/prohibition information in the following description. Such processing to display color material ejection permission/prohibition information based on the ejection permission/prohibition specification information is not processing unique to textile printers like the printing apparatus 1. Thus, a control method in which such processing is performed is also applicable to other printing apparatuses capable of receiving the ejection permission/prohibition specification information.

Hardware Configuration of the Control Apparatus

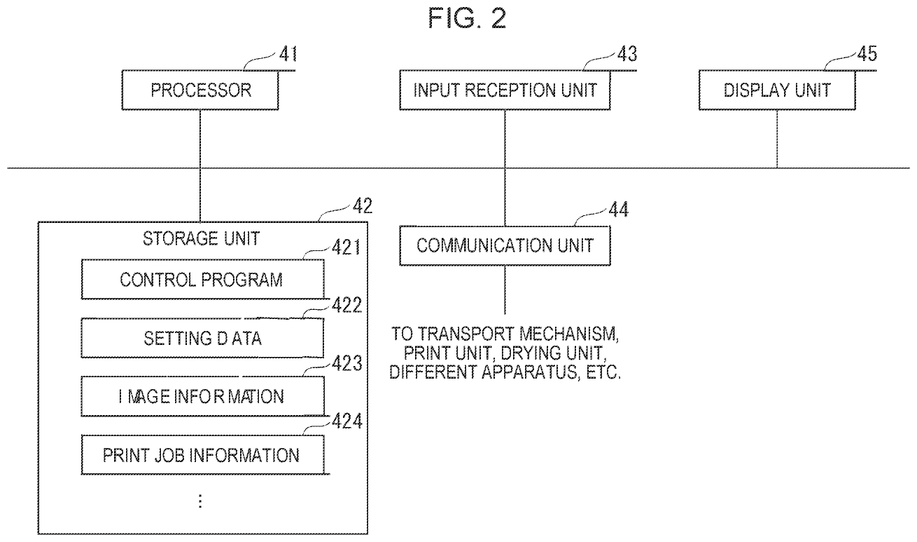

With reference to FIG. 2, the hardware configuration of the control apparatus 40 is described below. FIG. 2 is a diagram showing an example hardware configuration of the control apparatus 40.

The control apparatus 40 includes, for example, a processor 41, a storage unit 42, an input reception unit 43, a communication unit 44, and a display unit 45. These components are communicatively connected to one another via buses. Also, the control apparatus 40 communicates with each of the transport mechanism 10, the print unit 20, the drying unit 30, and other devices via the communication unit 44.

The processor 41 is, for example, a central processing unit (CPU). Note that instead of the CPU, the processor 41 may be other type of processor such as a digital signal processor (DSP) or a microcomputer. The processor 41 executes various programs stored in the storage unit 42. Note that the processor 41 may be formed by a plurality of pieces of hardware or may be formed by a single processor. The processor 41 may be a piece of hardware programmed to implement each function of the printing apparatus 1. In other words, the processor 41 may be of a configuration equipped with a control program 421 stored in the storage unit 42 as a hardware circuit. In this case, for example, the processor 41 is formed by an application-specific integrated circuit (ASIC), FPGA, or the like.

The storage unit 42 includes, for example, a hard disk drive (HDD), a solid-state drive (SSD), electrically erasable programmable read-only memory (EEPROM), read-only memory (ROM), random-access memory (RAM), or the like. Note that the storage unit 42 may be an external storage device coupled using, e.g., a digital input/output port such as USB, instead of being one incorporated into the control apparatus 40. The storage unit 42 stores therein, e.g., various pieces of information and various images to be processed by the control apparatus 40 as well as an operation program. Note that the storage unit 42 may be formed by a single storage device or may be formed by a plurality of storage devices. The plurality of storage devices may include a storage device of an information processing device separate from the control apparatus 40. In the example shown in FIG. 1, the storage unit 42 stores therein the control program 421, setting data 422, image information 423, and print job information 424.

The control program 421 is an example of a program executed by the processor 41.

The setting data 422 is an example of data including various setting values related to the operation of the printing apparatus 1.

The image information 423 is an example of image information indicating an image to be printed by the printhead 21 onto the print medium W.

The print job information 424 is an example of print job information. The print job information is now described in more details.

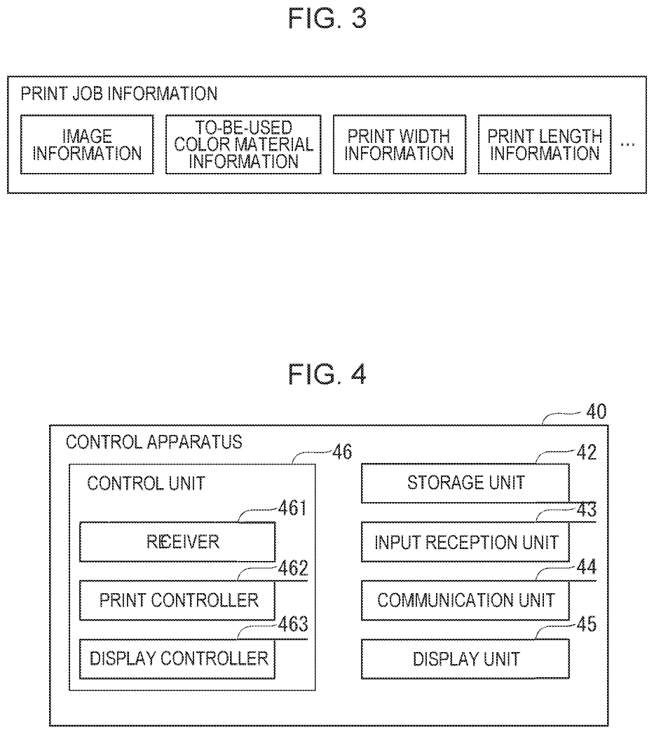

FIG. 3 is a diagram showing an example configuration of the print job information. As shown in FIG. 3, the print job information includes, as described earlier, image information, to-be-used color material information, print width information, and print length information. As described earlier, the print job information may be configured to include other information in addition to the image information, the to-be-used color material information, the print width information, and the print length information. This other information may be, for example, print condition information indicating a print condition. For example, the print condition includes information specifying, e.g., the print resolution, print density, and the amount of color material IK used per unit area, of the image to be printed by the printhead 21.

The input reception unit 43 is an input device, including a keyboard, a mouse, a touch panel, and the like. Note that the input reception unit 43 may be a touch panel formed integrally with the display unit 45.

The communication unit 44 is configured including, for example, a digital input/output port such as a USB port, an Ethernet (registered trademark) port, or the like.

The display unit 45 is a display device including, for example, a liquid crystal display panel, an organic electroluminescence (EL) display panel, or the like.

Note that the control apparatus 40 may be configured including various sensors (not shown). For example, the control apparatus 40 may be configured including sensors such as a nozzle sensor that detects ejection failure in a nozzle of the printhead 21 and a belt sensor that detects transport failure in the transport belt 14. The control apparatus 40 may be configured to monitor the operation status of the printing apparatus 1 by acquiring detection values from various sensors including these and make determinations.

### Functional Configuration of the Control Apparatus

With reference to FIG. 4, the functional configuration of the control apparatus 40 is described below. FIG. 4 is a diagram showing an example functional configuration of the control apparatus 40.

The control apparatus 40 includes the storage unit 42, the input reception unit 43, the communication unit 44, the display unit 45, and a control unit 46.

The control unit 46 performs overall control of the control apparatus 40. The control unit 46 includes a receiver 461, a print controller 462, and a display controller 463. These functional portions of the control unit 46 are implemented when, for example, the processor 41 executes various programs stored in the storage unit 42. Some or all of the functional portions may be a hardware functional portion such as large-scale integration (LSI) or an ASIC.

The receiver 461 receives various pieces of information via various images that the control apparatus 40 displays on the display unit 45. For example, the receiver 461 receives ejection permission/prohibition specification information on each of the 16 nozzles via the ejection permission/prohibition specification information reception image displayed on the display unit 45.

The print controller 462 controls the transport mechanism 10, the print unit 20, and the drying unit 30 to print an image onto a print medium W, the image being specified by the print job information. The image specified by the print job information is the image indicated by the image information included in the print job information.

The display controller 463 generates an image in accordance with an operation received. The display controller 463 displays the generated image on the display unit 45.

### Ejection Permission/Prohibition Specification Information Reception Image

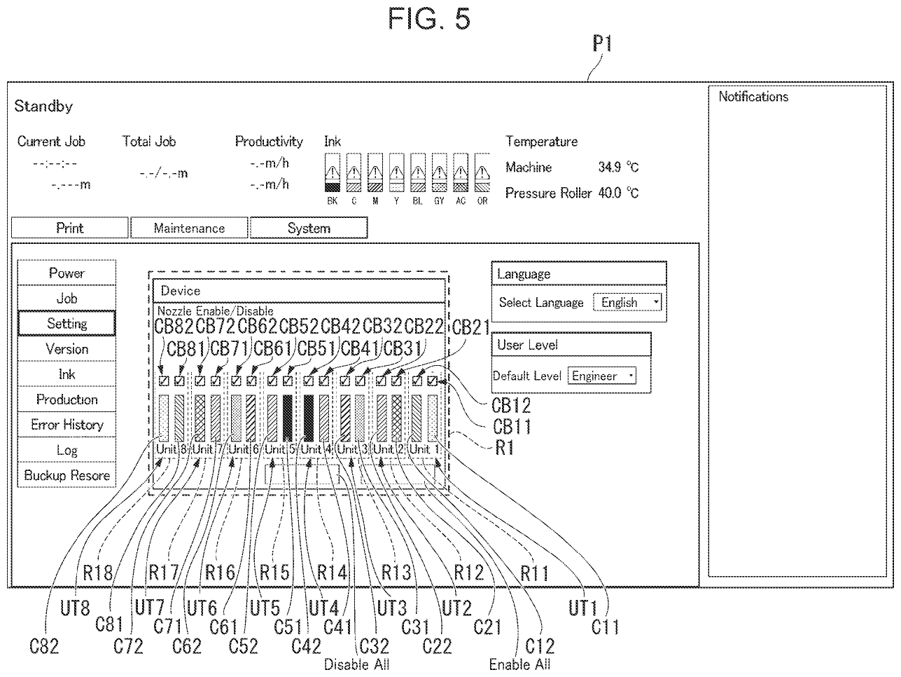

In response to an operation received, the printing apparatus 1 displays the ejection permission/prohibition specification information reception image on the display unit 45. FIG. 5 is a diagram showing an example of the ejection permission/prohibition specification information reception image. An image P1 shown in FIG. 5 is an example of the ejection permission/prohibition specification information reception image.

The image P1 includes a region R1. Note that the image P1 may be configured to include other images, other regions, other graphical user interfaces (GUIs), and the like. In the example shown in FIG. 5, the image P1 includes, in addition to the region R1, other images, other regions, other GUIs, and the like. However, these other images, other regions, other GUIs, and the like are not described in the embodiment.

The region R1 is an example of a region where GUIs for receiving the ejection permission/prohibition specification information are displayed. The region R1 includes a region R11, a region R12, a region R13, a region R14, a region R15, a region R16, a region R17, and a region R18.

The region R11 is a region associated with the first ejection unit. The region R11 includes information UT1, information C11, information C12, a checkbox CB11, and a checkbox CB12.

The region R12 is a region associated with the second ejection unit. The region R12 includes information UT2, information C21, information C22, a checkbox CB21, and a checkbox CB22.

The region R13 is a region associated with the third ejection unit. The region R13 includes information UT3, information C31, information C32, a checkbox CB31, and a checkbox CB32.

The region R14 is a region associated with the fourth ejection unit. The region R14 includes information UT4, information C41, information C42, a checkbox CB41, and a checkbox CB42.

The region R15 is a region associated with the fifth ejection unit. The region R15 includes information UT5, information C51, information C52, a checkbox CB51, and a checkbox CB52.

The region R16 is a region associated with the sixth ejection unit. The region R16 includes information UT6, information C61, information C62, a checkbox CB61, and a checkbox CB62.

The region R17 is a region associated with the seventh ejection unit. The region R17 includes information UT7, information C71, information C72, a checkbox CB71, and a checkbox CB72.

The region R18 is a region associated with the eighth ejection unit. The region R18 includes information UT8, information C81, information C82, a checkbox CB81, and a checkbox CB82.

The region R11 to the region R18 are regions associated with different ejection units and have substantially the same configuration. Thus, the following takes the region R11 as an example to describe the configuration of each of the regions R11 to R18.

The information UT1 is an example of information indicating the first ejection unit. In the example shown in FIG. 5, the information UT1 is a character string “Unit 1”. Note that instead of this character string, the information UT1 may be other information indicative of the first ejection unit.

The information C11 is information indicating the color material IK associated with one of the two nozzles of the first ejection unit. In the example shown in FIG. 5, the information C11 is a rectangular graphic filled with the color of the corresponding color material IK. Note that the information C11 may be other information that can indicate the corresponding color material IK.

The information C12 is information indicating the color material IK associated with one of the two nozzles of the second ejection unit. In the example shown in FIG. 5, the information C12 is a rectangular graphic filled with the color of the corresponding color material IK. Note that the information C12 may be other information that can indicate the corresponding color material IK.

The checkbox CB11 is displayed at a position associated with the information C11. In the example shown in FIG. 5, the checkbox CB11 is displayed at a position upwardly adjacent to the information C11, inside the region R11. The checkbox CB11 is a GUI for receiving an operation for specifying whether to permit or prohibit ejection of the color material IK indicated by the information C11. When a select operation is performed on the checkbox CB11 with the checkbox CB11 being overlaid with no image indicating that a select operation has been performed on the checkbox CB11, the checkbox CB11 is overlaid with an image indicating that a select operation has been performed on the checkbox CB11. When a select operation is performed on the checkbox CB11 with the checkbox CB11 being overlaid with an image indicating that a select operation has been performed on the checkbox CB11, the checkbox CB11 is removed of the image indicating that a select operation has been performed on the checkbox CB11. Note that the select operation herein refers to a click, a tap, or the like. For the convenience of illustration, a GUI like the checkbox CB11, i.e., an image indicating that a select operation has been performed on a checkbox is referred to as a check mark in the following description. When the checkbox CB11 is overlaid with a check mark, the control apparatus 40 identifies that the color material IK indicated by the information C11 is being specified as being permitted to be ejected. Thus, in this case, the control apparatus 40 receives the ejection permission/prohibition specification information specifying that a nozzle, among the 16 nozzles of the printhead 21, which is associated with the color material IK indicated by the information C11 is permitted to eject the color material IK. Meanwhile, when the checkbox CB11 is overlaid with no check mark, the control apparatus 40 identifies that the color material IK indicated by the information C11 is being specified as being prohibited from being ejected. Thus, in this case, the control apparatus 40 receives the ejection permission/prohibition specification information specifying that a nozzle, among the 16 nozzles of the printhead 21, which is associated with the color material IK indicated by the information C11 is prohibited from ejecting the color material IK.

The checkbox CB12 is displayed at a position associated with the information C12. In the example shown in FIG. 5, the checkbox CB12 is shown at a position upwardly adjacent to the information C12, inside the region R11. The checkbox CB12 is a GUI for receiving an operation for specifying whether to permit or prohibit ejection of the color material IK indicated by the information C12. The configuration of the checkbox CB12 is substantially the same as that of the checkbox CB11. Thus, a detailed description of the checkbox CB12 is omitted here.

The above configuration allows a user to specify whether to permit or prohibit ejection of the color material IK indicated by the information C11 by performing a select operation on the checkbox CB11. In other words, the user can specify to either permit ejection of the color material IK indicated by the information C11 or prohibit ejection of the color material IK indicated by the information C11 by performing a select operation on the checkbox CB11. The control apparatus 40 thus receives, from a user via the checkbox CB11, the ejection permission/prohibition specification information specifying whether a nozzle, among the 16 nozzles of the printhead 21, which is associated with the color material IK indicated by the information C11 is permitted to eject or prohibited from ejecting the color material IK. Also, the user can specify whether to permit or prohibit ejection of the color material IK indicated by the information C12 by performing a select operation on the checkbox CB12. In other words, the user can specify to either permit ejection of the color material IK indicated by the information C12 or prohibit ejection of the color material IK indicated by the information C12 by performing a select operation on the checkbox CB12. The control apparatus 40 thus receives, from a user via the checkbox CB12, the ejection permission/prohibition specification information specifying whether a nozzle, among the 16 nozzles of the printhead 21, which is associated with the color material IK indicated by the information C12 is permitted to eject or prohibited from ejecting the color material IK.

Thus, the user can specify whether to permit or prohibit ejection of the color material IK indicated by the information C21 by performing a select operation on the checkbox CB21. The control apparatus 40 thus receives, from a user via the checkbox CB21, the ejection permission/prohibition specification information specifying whether a nozzle, among the 16 nozzles of the printhead 21, which is associated with the color material IK indicated by the information C21 is permitted to eject or prohibited from ejecting the color material IK. Also, the user can specify whether to permit or prohibit ejection of the color material IK indicated by the information C22 by performing a select operation on the checkbox CB22. The control apparatus 40 thus receives, from a user via the checkbox CB22, the ejection permission/prohibition specification information specifying whether a nozzle, among the 16 nozzles of the printhead 21, which is associated with the color material IK indicated by the information C22 is permitted to eject or prohibited from ejecting the color material IK. Also, the user can specify whether to permit or prohibit ejection of the color material IK indicated by the information C31 by performing a select operation on the checkbox CB31. The control apparatus 40 thus receives, from a user via the checkbox CB31, the ejection permission/prohibition specification information specifying whether a nozzle, among the 16 nozzles of the printhead 21, which is associated with the color material IK indicated by the information C31 is permitted to eject or prohibited from ejecting the color material IK. Also, the user can specify whether to permit or prohibit ejection of the color material IK indicated by the information C32 by performing a select operation on the checkbox CB32. The control apparatus 40 thus receives, from a user via the checkbox CB32, the ejection permission/prohibition specification information specifying whether a nozzle, among the 16 nozzles of the printhead 21, which is associated with the color material IK indicated by the information C32 is permitted to eject or prohibited from ejecting the color material IK. Also, the user can specify whether to permit or prohibit ejection of the color material IK indicated by the information C41 by performing a select operation on the checkbox CB41. The control apparatus 40 thus receives, from a user via the checkbox CB41, the ejection permission/prohibition specification information specifying whether a nozzle, among the 16 nozzles of the printhead 21, which is associated with the color material IK indicated by the information C41 is permitted to eject or prohibited from ejecting the color material IK. Also, the user can specify whether to permit or prohibit ejection of the color material IK indicated by the information C42 by performing a select operation on the checkbox CB42. The control apparatus 40 thus receives, from a user via the checkbox CB42, the ejection permission/prohibition specification information specifying whether a nozzle, among the 16 nozzles of the printhead 21, which is associated with the color material IK indicated by the information C42 is permitted to eject or prohibited from ejecting the color material IK. Also, the user can specify whether to permit or prohibit ejection of the color material IK indicated by the information C51 by performing a select operation on the checkbox CB51. The control apparatus 40 thus receives, from a user via the checkbox CB51, the ejection permission/prohibition specification information specifying whether a nozzle, among the 16 nozzles of the printhead 21, which is associated with the color material IK indicated by the information C51 is permitted to eject or prohibited from ejecting the color material IK. Also, the user can specify whether to permit or prohibit ejection of the color material IK indicated by the information C52 by performing a select operation on the checkbox CB52. The control apparatus 40 thus receives, from a user via the checkbox CB52, the ejection permission/prohibition specification information specifying whether a nozzle, among the 16 nozzles of the printhead 21, which is associated with the color material IK indicated by the information C52 is permitted to eject or prohibited from ejecting the color material IK. Also, the user can specify whether to permit or prohibit ejection of the color material IK indicated by the information C61 by performing a select operation on the checkbox CB61. The control apparatus 40 thus receives, from a user via the checkbox CB61, the ejection permission/prohibition specification information specifying whether a nozzle, among the 16 nozzles of the printhead 21, which is associated with the color material IK indicated by the information C61 is permitted to eject or prohibited from ejecting the color material IK. Also, the user can specify whether to permit or prohibit ejection of the color material IK indicated by the information C62 by performing a select operation on the checkbox CB62. The control apparatus 40 thus receives, from a user via the checkbox CB62, the ejection permission/prohibition specification information specifying whether a nozzle, among the 16 nozzles of the printhead 21, which is associated with the color material IK indicated by the information C62 is permitted to eject or prohibited from ejecting the color material IK. Also, the user can specify whether to permit or prohibit ejection of the color material IK indicated by the information C71 by performing a select operation on the checkbox CB71. The control apparatus 40 thus receives, from a user via the checkbox CB71, the ejection permission/prohibition specification information specifying whether a nozzle, among the 16 nozzles of the printhead 21, which is associated with the color material IK indicated by the information C71 is permitted to eject or prohibited from ejecting the color material IK. Also, the user can specify whether to permit or prohibit ejection of the color material IK indicated by the information C72 by performing a select operation on the checkbox CB72. The control apparatus 40 thus receives, from a user via the checkbox CB72, the ejection permission/prohibition specification information specifying whether a nozzle, among the 16 nozzles of the printhead 21, which is associated with the color material IK indicated by the information C72 is permitted to eject or prohibited from ejecting the color material IK. Also, the user can specify whether to permit or prohibit ejection of the color material IK indicated by the information C81 by performing a select operation on the checkbox CB81. The control apparatus 40 thus receives, from a user via the checkbox CB81, the ejection permission/prohibition specification information specifying whether a nozzle, among the 16 nozzles of the printhead 21, which is associated with the color material IK indicated by the information C81 is permitted to eject or prohibited from ejecting the color material IK. Also, the user can specify whether to permit or prohibit ejection of the color material IK indicated by the information C82 by performing a select operation on the checkbox CB82. The control apparatus 40 thus receives, from a user via the checkbox CB82, the ejection permission/prohibition specification information specifying whether a nozzle, among the 16 nozzles of the printhead 21, which is associated with the color material IK indicated by the information C82 is permitted to eject or prohibited from ejecting the color material IK.

### Print Job Information List

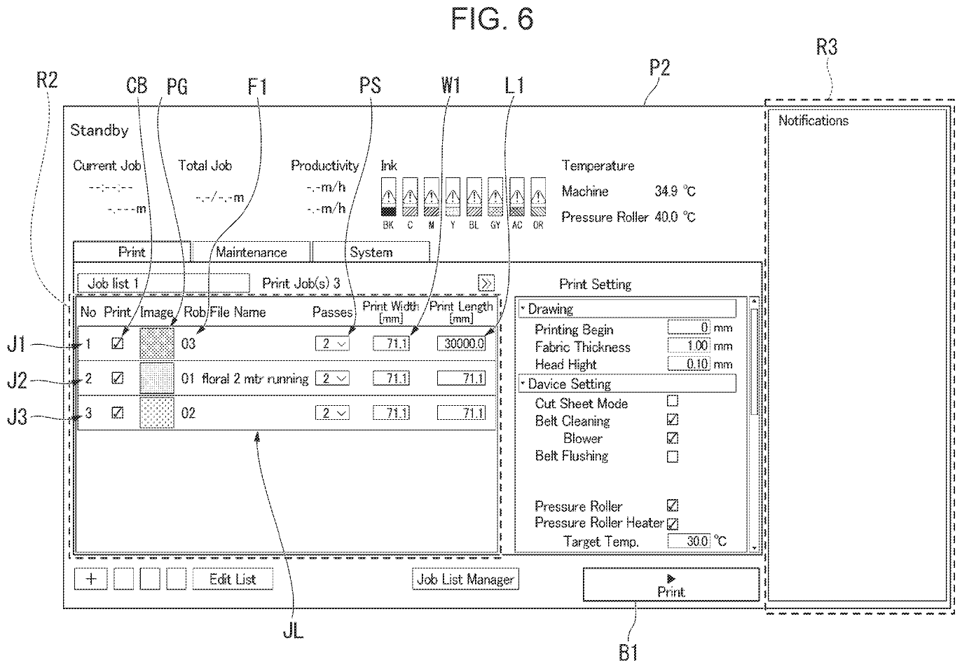

In response to an operation received, the printing apparatus 1 displays an image containing a print job information list on the display unit 45. For the convenience of illustration, this image is referred to as a first image P2 in the following description. FIG. 6 is a diagram showing an example of the first image P2. In the example shown in FIG. 6, the first image P2 is an image for receiving an operation for specifying various pieces of printing-related information. Note that instead of this image, the first image P2 may be other type of image.

The first image P2 includes a region R2, a region R3, and a button B1. Note that the first image P2 may be configured to include other images, other regions, other GUIs, and the like. In the example shown in FIG. 6, the first image P2 includes other images, other regions, other GUIs, and the like in addition to the region R2, the region R3, and the button B1. However, these other images, other regions, other GUIs, and the like are not described in the embodiment.

The region R2 is an example region where a print job information list is displayed. A list JL shown in FIG. 6 is an example of the print job information list. The list JL includes three pieces of print job information: print job information J1, print job information J2, and print job information J3.

In the example shown in FIG. 6, the print job information J1 is displayed inside the region R2 by six GUIs: a checkbox CB, a region PG, a region F1, a drop-down menu PS, a text box W1, and a text box L1. Note that the print job information J1 may be configured to include, in addition to these six GUIs, other images, other pieces of information, other GUIs, and the like. Also, the print job information J1 may be configured not to include at least one of the region F1 and the drop-down menu PS.

The checkbox CB is a checkbox associated with the print job information J1. The checkbox CB is a GUI for receiving an operation for specifying whether or not to execute printing in accordance with the print job information J1. In other words, the checkbox CB is a GUI for specifying the print job information J1 as specified print job information. When a select operation is performed on the checkbox CB with the checkbox CB overlaid with no check mark, the checkbox CB is overlaid with a check mark. When a select operation is performed on the checkbox CB with the checkbox CB overlaid with a check mark, the checkbox CB is removed of the check mark. When an operation for starting printing is received with the checkbox CB being overlaid with a check mark, the control apparatus 40 executes printing in accordance with the print job information J1. Meanwhile, when an operation for starting printing is received with the checkbox CB being overlaid with no check mark, the control apparatus 40 does not execute printing in accordance with the print job information J1. Thus, by performing a select operation on the checkbox CB, the user can specify whether or not to perform printing in accordance with the print job information J1 from among the three pieces of print job information included in the list JL. In other words, by performing a select operation on the checkbox CB, the user can specify the print job information J1 as specified print job information or cancel the specification of the print job information J1 as specified print job information.

The region PG is a region associated with the print job information J1. The region PG is a region where image information is displayed, the image information indicating an image to be printed based on the print job information J1. In the example shown in FIG. 6, this image information is a thumbnail image of the image. When a select operation is performed on the image information, the control apparatus 40 displays a print image reception image for receiving an operation for specifying an image to be printed based on the print job information J1. When an image to be printed based on the print job information J1 is specified via the print image reception image, the control apparatus 40 displays the image information indicating the specified image in the region PG. Thus, by performing a select operation on the region PG, the user can specify the image to be printed based on the print job information J1. When an operation for starting printing is received with the checkbox CB being overlaid with a check mark and with image information indicating a certain image being displayed in the region PG, the control apparatus 40 prints the image, as printing in accordance with the print job information J1.

The region F1 is a region associated with the print job information J1. The region F1 is a region to display file name information indicating the file name of the print job information J1.

The drop-down menu PS is a GUI associated with the print job information J1. The drop-down menu PS is a GUI for specifying a value indicative of passes for the printing in accordance with the print job information J1. When a select operation is performed on the drop-down menu PS, the control apparatus 40 displays a list of one or more values selectable as the aforementioned value. When a select operation is performed on one of the one or more values included in the list displayed, the control apparatus 40 displays, in the drop-down menu PS, only the value selected by the select operation. When an operation for starting printing is received with the checkbox CB being overlaid with a check mark and with a certain value being displayed in the drop-down menu PS, the control apparatus 40 performs the printing in accordance with the print job information J1 using this value as passes.

The text box W1 is a GUI associated with the print job information J1. The text box W1 is a GUI for specifying print width. When an operation for entering a certain value in the text box is received, the control apparatus 40 displays the value in the text box W1. When an operation for starting printing is received with the checkbox CB being overlaid with a check mark and with a certain value being displayed in the text box W1, the control apparatus 40 performs the printing in accordance with the print job information J1 using this value as print width.

The text box L1 is a GUI associated with the print job information J1. The text box L1 is a GUI for specifying print width. When an operation for entering a certain value in the text box is received, the control apparatus 40 displays the value in the text box L1. When an operation for starting printing is received with the checkbox CB being overlaid with a check mark and with a certain value being displayed in the text box L1, the control apparatus 40 performs the printing in accordance with the print job information J1 using this value as print width.

The print job information J2 and the print job information J3 have the same configuration as the print job information J1 and are therefore not described here. For the convenience of illustration, among the GUIs associated with certain print job information, a GUI that corresponds to the checkbox CB is referred to as a checkbox associated with the print job information in the following description.

The region R3 is a region where various pieces of warning information are displayed. In the example shown in FIG. 6, no warning information is displayed in the region R3. The color material ejection permission/prohibition information described earlier is an example of the warning information displayed in the region R3.

The button B1 is a GUI for receiving an operation for starting printing. When a select operation is performed on the button B1, the control apparatus 40 identifies, in the list JL, print job information associated with a checkbox overlaid with a check mark, one by one from the top. In other words, in this case, the control apparatus 40 identifies specified print job information one by one from the top. The control apparatus 40 converts each of the identified one or more pieces of specified print job information into a print job in the order in which they are identified. Then, the control apparatus 40 performs printing based on the thus-converted print jobs in the order of the conversion into the print jobs.

In this way, the user can edit print job information via the first image P2. Then via the first image P2, the user can cause the control apparatus 40 to start printing in accordance with the print job information thus edited.

### Displaying Color Material Ejection Permission/Prohibition Information on the First Image

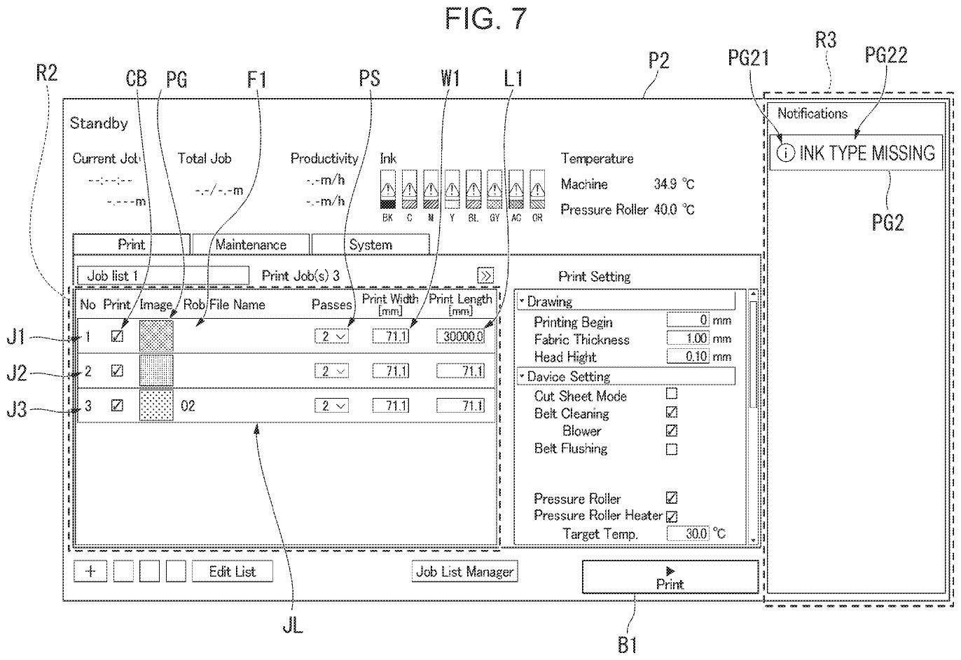

With reference to FIG. 7, a description is given below of displaying the color material ejection permission/prohibition information on the first image P2. FIG. 7 is a diagram showing an example of the first image P2 in which the color material ejection permission/prohibition information is displayed in the region R3. An image PG2 inside the region R3 is an example of the color material ejection permission/prohibition information displayed on the first image P2.

When a select operation is performed on the button B1, the control apparatus 40 specifies one or more pieces of specified print job information included in the list JL. As an example, the following describes a case where only the print job information J1 is the one or more pieces of specified print job information included in the list JL. In this case, the control apparatus 40 identifies the print job information J1 as the specified print job information included in the list JL. Also, in this case, the control apparatus 40 identifies ejection permitted nozzles from among the 16 nozzles of the printhead 21 based on the ejection permission/prohibition specification information received in advance via the ejection permission/prohibition specification information reception image, and identifies a combination of the color materials IK associated with the ejection permitted nozzles as a combination of color materials IK to be ejected from the ejection permitted nozzles. Note that this ejection permission/prohibition specification information is ejection permission/prohibition specification information on each of the color materials IK associated with the respective 16 nozzles.

Then, the control apparatus 40 determines whether the combination of one or more types of color materials IK indicated by the to-be-used color material information included in the print job information J1 identified is covered by the combination of color materials IK associated with the ejection permitted nozzles identified. However, in this determination, among the color materials IK ejected from the respective 16 nozzles of the printhead 21, the control apparatus 40 handles the color materials IK that are the same in type as one color material IK. In other words, in this example, the control apparatus 40 identifies, from the eight types of color materials IK, a combination of color materials IK associated with the identified ejection permitted nozzles. For the convenience of illustration, a combination of one or more types of color materials IK indicated by the to-be-used color material information included in the print job information is referred to as a first combination in the following description. Note that the first combination is, in other words, a combination of one or more types of color materials IK to be used to print an image. For the convenience of illustration, the combination of color materials IK associated with the ejection permitted nozzles is referred to as a second combination in the following description. When the first combination includes a color material IK of a type not included in the second combination, the control apparatus 40 determines that the first combination is not covered by the second combination. For example, when the first combination includes a color material IK associated with an ejection prohibited nozzle, the control apparatus 40 determines that the first combination is not covered by the second combination. In other words, when the first combination includes a color material IK to be ejected from an ejection prohibited nozzle, the control apparatus 40 determines that the first combination is not covered by the second combination. Also, for example, when the first combination includes a color material IK associated with none of the 16 nozzles, the control apparatus 40 determines that the first combination is not covered by the second combination. In other words, when the first combination includes a color material IK of a type retained in the color material container 24 not attached to the print unit 20, the control apparatus 40 determines that the first combination is not covered by the second combination. Meanwhile, when the second combination includes all the one or more types of color materials IK included in the first combination, the control apparatus 40 determines that the first combination is covered by the second combination.

When it is determined that the first combination is not covered by the second combination, the control apparatus 40 displays the color material ejection permission/prohibition information on the display unit 45.

The color material ejection permission/prohibition information is information indicating permission or prohibition of ejection about at least one of the one or more types of color materials IK to be used for the printing in accordance with the print job information J1. As an example, the following describes a case where the color material ejection permission/prohibition information is information indicating prohibition of ejection about a color material IK associated with an ejection prohibited nozzle among the one or more types of color materials IK. In this case, for example, the color material ejection permission/prohibition information includes at least one of a warning image and a print preview image of an image indicated by the image information included in the print job information J1, the warning image warning that the combination of color materials IK to be used for the printing in accordance with the print job information J1 includes a color material IK to be ejected from an ejection prohibited nozzle. Note that the color material ejection permission/prohibition information may be configured to include, instead of one or both of these pieces of information, other information indicating prohibition of ejection about the color material IK associated with an ejection prohibited nozzle among the one or more types of color materials IK. In the example shown in FIG. 7, the image PG2 includes, as an example of the warning image, an image PG21 warning that the combination of color materials IK to be used for the printing in accordance with the print job information J1 includes a color material IK to be ejected from an ejection prohibited nozzle. Also, in this case, the image PG2 includes a character string PG22 saying “INK TYPE MISSING” as another example of information warning that the combination of color materials IK to be used for the printing in accordance with the print job information J1 includes a color material IK to be ejected from an ejection prohibited nozzle.

As mentioned earlier, the color material ejection permission/prohibition information may include a print preview image of the image indicated by the image information included in the print job information J1. In this case, the print preview image may be displayed in the region R3 or may be displayed in other region inside the first image P2. The print preview image is a print preview image of what an image would look like when the image is printed by one or more of the one or more types of color materials IK included in the first combination which are left over after exclusion of a color material IK not included in the second combination. For example, when the color of the color material IK which is one of the one or more types of color materials IK included in the first combination and which is not included in the second combination is red, the control apparatus 40 generates a print preview image of what an image would look like when the image is printed using one or more of the one or more types of color materials IK included in the first combination which are left over after exclusion of the red color material IK. Then, the control apparatus 40 displays the generated print preview image in the region R3. In this case, the control apparatus 40 can visually convey to the user that ejection of a color material IK of a certain color, i.e., a color material IK of a certain type is prohibited.

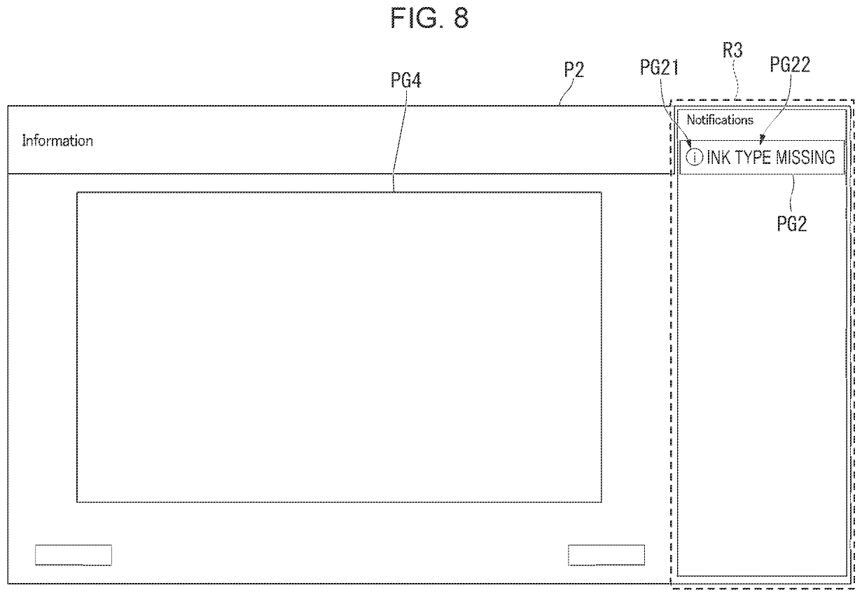

Such a print preview image may be configured to be displayed on the display unit 45 in response to a select operation performed on the image PG2. FIG. 8 is a diagram showing an example print preview image displayed on the display unit 45 in response to a select operation performed on the image PG2. An image PG4 shown in FIG. 8 is an example print preview image overlaying a region which is in the area of the first image P2 and is outside the region R2. This print preview image is, as described earlier, a print preview image of what an image would look like when the image is printed using one or more of the one or more types of color materials IK included in the first combination which are left over after exclusion of the color material IK not included in the second combination.

Also, the color material ejection permission/prohibition information may be configured to include other information. For example, the color material ejection permission/prohibition information may be configured to include information suggesting modification of the print job information J1. In this case, the control apparatus 40 can inform the user that there is a possibility that the print job information has been inputted incorrectly. The color material ejection permission/prohibition information may also be configured to include information indicating that, among the one or more types of color materials IK to be used for the printing in accordance with the print job information J1, ejection is permitted for the color material IK associated with an ejection permitted nozzle.

### Processing Performed by the Control Apparatus to Display the Color Material Ejection Permission/Prohibition Information

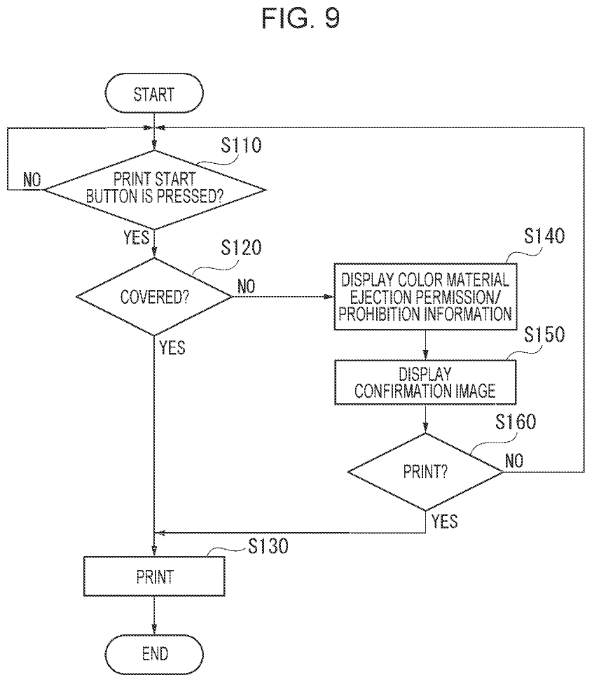

With reference to FIG. 9, the following describes processing performed by the control apparatus 40 to display the color material ejection permission/prohibition information. FIG. 9 is an example flowchart of the processing performed by the control apparatus 40 to display the color material ejection permission/prohibition information. As an example, the following describes a case where the ejection permission/prohibition specification information is received in advance via the image P1 at a timing before the processing in Step S110 shown in FIG. 9 is performed. Also, as an example, the following describes a case where at this timing, the first image P2 is being displayed on the display unit 45. Also, as an example, the following describes a case where only the print job information J1 is the one or more pieces of specified print job information included in the list JL.

The display controller 463 stands by until a select operation is performed on the button B1 (Step S110). In the example shown in FIG. 9, the processing in Step S110 is shown as “PRINT START BUTTON IS PRESSED?”.

When it is determined that a select operation has been performed on the button B1 (Step S110: YES), the display controller 463 identifies specified print job information from among one or more pieces of print job information included in the list JL. In this example, the display controller 463 identifies the print job information J1 as the specified print job information. The display controller 463 then identifies, as a first combination, a combination of one or more types of color materials IK indicated by the to-be-used color material information included in the print job information J1 identified as the specified print job information. The display controller 463 also identifies, as a second combination, a combination of color materials IK associated with ejection permitted nozzles based on the ejection permission/prohibition specification information received in advance via the ejection permission/prohibition specification information reception image. The display controller 463 then determines whether the first combination identified is covered by the second combination identified (Step S120). In the example shown in FIG. 9, the processing in Step S120 is shown as “COVERED?”.

When the display controller 463 determines that the first combination identified is covered by the second combination identified (Step S120: YES), the print controller 462 performs printing in accordance with the print job information J1 identified as the specified print job information (Step S130), and the processing of the flowchart shown in FIG. 9 ends.

Meanwhile, when it is determined that the first combination identified is not covered by the second combination identified (Step S120: NO), the display controller 463 displays the color material ejection permission/prohibition information in the region R3 (Step S140).

Next, the display controller 463 generates a confirmation image for receiving an operation for specifying whether to perform printing in accordance with the print job information J1 identified as the specified print job information. The display controller 463 displays the generated confirmation image on the display unit 45 (Step S150).

Next, the display controller 463 determines whether to perform the printing in accordance with the print job information J1 identified as the specified print job information (Step S160). Specifically, the display controller 463 determines to perform the printing when an operation for specifying to perform the printing is received via the confirmation image displayed on the display unit 45 in Step S150. Meanwhile, the display controller 463 determines not to perform the printing when an operation for specifying not to perform the printing is received via the confirmation image.

When it is determined not to perform the printing in accordance with the print job information J1 identified as the specified print job information (Step S160: NO), the display controller 463 proceeds to Step S110 and again stands by until a select operation is performed on the button B1.

Meanwhile, when it is determined to perform the printing in accordance with the print job information J1 identified as the specified print job information (Step S160: YES), the display controller 463 proceeds to Step S130 and performs the printing, and after that, the processing in the flowchart shown in FIG. 9 ends.

As thus described, the control apparatus 40 receives ejection permission/prohibition specification information specifying, for each of one or more nozzles of the printhead 21, whether the nozzle is permitted to eject or prohibited from ejecting a color material IK, and then based on the print job information including the image information indicating the image to be printed on a print medium and on the ejection permission/prohibition specification information received, displays color material ejection permission/prohibition information on the display unit 45, the color material ejection permission/prohibition information indicating permission or prohibition of ejection about at least one of the one or more types of color materials IK to be used for the printing in accordance with the print job information J1. The control apparatus 40 can thus reduce the risk of an image being printed while some of the one or more types of color materials IK to be used to print the image is prohibited from being ejected.

Note that, instead of being configured to display the color material ejection permission/prohibition information on the display unit 45, the control apparatus 40 may be configured to output the color material ejection permission/prohibition information to a different apparatus to display the color material ejection permission/prohibition information on a display unit of the different apparatus. Also, the different apparatus may be an apparatus formed integrally with the printing apparatus 1 or an apparatus separate from the printing apparatus 1. Examples of the different apparatus include, but are not limited to, information processing apparatuses such as a multi-function mobile phone terminal (a smartphone), a mobile phone terminal, a table personal computer (PC), a personal digital assistant (PDA), a laptop PC, a desktop PC, and a workstation.

Also, the processing in Step S110 described above may be processing to stand by until the specified print job information is specified via the list JL. In this case, the control apparatus 40 performs steps from Step S120 onward for the print job information specified as the specified print job information.

Also, the processing in Step S110 described above may be processing to stand by until a predetermined processing start condition is met. In this case, the processing start condition may be any processing.

Modification of Processing Performed by the Control Apparatus to Display the Color Material Ejection Permission/Prohibition Information

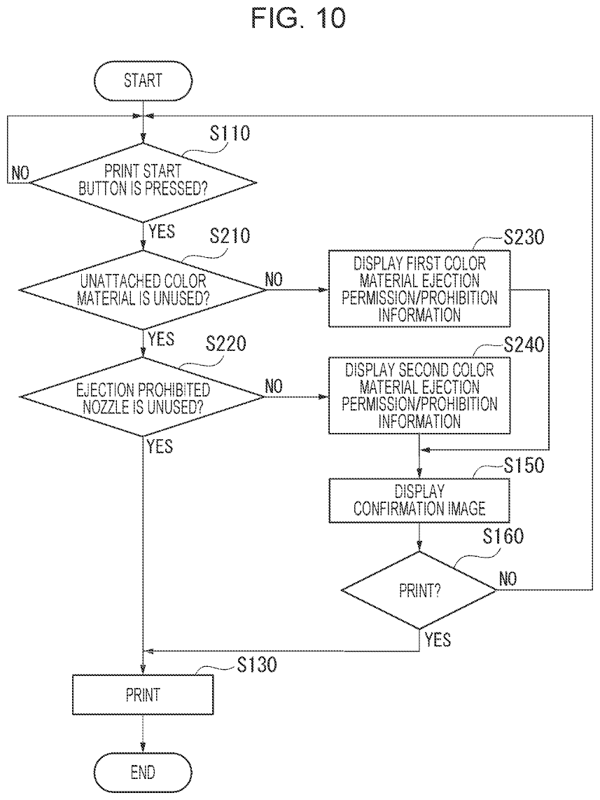

A description is given below of a modification of the processing performed by the control apparatus 40 to display color material ejection permission/prohibition information. In the modification of the processing performed by the control apparatus 40 to display color material ejection permission/prohibition information, the processing in Step S120 is divided into two determination processing steps: Step S210 and Step S220, as shown in FIG. 10. Accordingly, the processing in Step S140 is divided into two display processing steps: Step S230 and Step S240. FIG. 10 is another flowchart of processing performed by the control apparatus 40 to display the color material ejection permission/prohibition information. Note that the processing in Step S110, the processing in Step S130, the processing in Step S150, and the processing in Step S160 shown in FIG. 10 are the same as the processing in Step S110, the processing in Step S130, the processing in Step S150, and the processing in Step S160 shown in FIG. 9, respectively, and are therefore not described here. Also, as an example, the following describes a case where the ejection permission/prohibition specification information is received in advance via the image P1 at a timing before the processing in Step S110 shown in FIG. 10 is performed. Also, as an example, the following describes a case where at this timing, the first image P2 is being displayed on the display unit 45. Also, as an example, the following describes a case where only the print job information J1 is the one or more pieces of specified print job information included in the list JL.

When it is determined in the processing in S110 shown in FIG. 10 that a select operation has been performed on the button B1, the display controller 463 identifies the specified print job information from among the one or more pieces of print job information included in the list JL. In this example, the display controller 463 identifies the print job information J1 as the specified print job information. The display controller 463 then identifies, as a first combination, a combination of one or more types of color materials IK indicated by the to-be-used color material information included in the print job information J1 identified as the specified print job information. The display controller 463 also identifies ejection permitted nozzles from among the 16 nozzles of the printhead 21 based on the ejection permission/prohibition specification information received in advance via the ejection permission/prohibition specification information reception image, and identifies, as a second combination, a combination of color materials IK associated with the ejection permitted nozzles. After that, the display controller 463 determines whether the first combination includes a color material IK associated with none of the 16 nozzles of the printhead 21 (Step S210). In the example shown in FIG. 10, the processing in Step S210 is shown as “UNATTACHED COLOR MATERIAL IS UNUSED?”.

When it is determined that the first combination does not include a color material IK associated with none of the 16 nozzles of the printhead 21 (Step S210: YES), the display controller 463 determines whether the first combination includes a color material IK associated with an ejection prohibited nozzle (Step S220). In the example shown in FIG. 10, the processing in Step S220 is shown as “EJECTION PROHIBITED NOZZLE IS UNUSED?”.

When it is determined that the first combination does not include a color material IK associated with an ejection prohibited nozzle (Step S220: YES), the display controller 463 proceeds to Step S130 shown in FIG. 10 to perform the printing in accordance with the print job information J1 identified as the specified print job information in Step S210, and the processing in the flowchart shown in FIG. 10 ends.

Meanwhile, when it is determined that the first combination includes a color material IK associated with an ejection prohibited nozzle (Step S220: NO), the display controller 463 determines that the first combination is not covered by the second combination, and displays second color material ejection permission/prohibition information on the display unit 45 (Step S240). The second color material ejection permission/prohibition information is information including, in addition to the color material ejection permission/prohibition information described in the embodiment, information indicating that the first combination includes a color material IK associated with an ejection prohibited nozzle. The control apparatus 40 thus can inform the user that correction of the ejection permission/prohibition specification information is going to enable the printing in accordance with the print job information J1, which is the specified print job information in this example, to be performed normally. After performing the processing in Step S240, the display controller 463 proceeds to Step S150 shown in FIG. 10 to display a confirmation image. Note that the second color material ejection permission/prohibition information may be configured to include other information in addition to the color material ejection permission/prohibition information described in the embodiment and the information indicating that the first combination includes a color material IK associated with an ejection prohibited nozzle.

Meanwhile, when it is determined that the first combination includes a color material IK associated with none of the 16 nozzles of the printhead 21 (Step S210: NO), the display controller 463 determines that the first combination is not covered by the second combination and displays first color material ejection permission/prohibition information on the display unit 45 (Step S230). The first color material ejection permission/prohibition information is information including, in addition to the color material ejection permission/prohibition information described in the embodiment, information indicating that the first combination includes a color material IK associated with none of the 16 nozzles of the printhead 21. The control apparatus 40 can thus inform the user that correction of the print job information J1, which is the specified print job information in this example, is going to enable the printing in accordance with the print job information J1 to be performed normally. After performing the processing in Step S230, the display controller 463 proceeds to Step S150 shown in FIG. 10 to display a confirmation image. Note that the first color material ejection permission/prohibition information may be configured to include other information in addition to the color material ejection permission/prohibition information described in the embodiment and the information indicating that the first combination includes a color material IK associated with none of the 16 nozzles of the printhead 21.

As thus described, by executing the processing in the flowchart in FIG. 10, the control apparatus 40 can not only reduce the risk of an image being printed while some of the one or more color materials IK used to print the image is missing, but also inform the user of why some of the one or more color materials IK is missing.

Note that instead of being configured to display at least one of the first color material ejection permission/prohibition information and the second color material ejection permission/prohibition information on the display unit 45, the control apparatus 40 may be configured to output the above information to a different apparatus so that the information may be displayed on a display unit of the different apparatus. The different apparatus may be an apparatus formed integrally with the printing apparatus 1 or an apparatus separate from the printing apparatus 1. Examples of the different apparatus include, but are not limited to, information processing apparatuses such as a multi-function mobile phone terminal, a mobile phone terminal, a table PC, a PDA, a laptop PC, a desktop PC, and a workstation.

As thus described, the control apparatus according to the embodiment is a control apparatus that controls a printing apparatus having one or more nozzles associated with a color material to eject, the control apparatus comprising: a receiver that receives ejection permission/prohibition specification information specifying, for each of the one or more nozzles, whether the nozzle is permitted to eject or prohibited from ejecting the color material and a display controller that displays, on a display unit, based on the ejection permission/prohibition specification information received by the receiver and print job information including image information indicating an image to be printed on a print medium, information indicating permission or prohibition of ejection about at least one of one or more types of color materials to be used for printing in accordance with the print job information. Thus, the control apparatus can reduce the risk of an image being printed while some of the one or more color materials used to print the image is prohibited from being ejected. In the example described above, the control apparatus 40 is an example of this control apparatus. Also, in the example described above, the color material IK is an example of the color material. Also, in the example described above, the printing apparatus 1 is an example of the printing apparatus. Also, in the example described above, the receiver 461 is an example of the receiver. Also, in the example described above, the print job information J1 to the print job information J3 are each an example of the print job information. Also, in the example described above, the image PG2 is an example of the information. Also, in the example described above, the display unit 45 is an example of the display unit. Also, in the example described above, the display controller 463 is an example of the display controller.

The control apparatus may employ a configuration such that the information indicating permission or prohibition of ejection about at least one of one or more types of color materials to be used for printing in accordance with the print job information includes a print preview image of the image indicated by the image information. In the example described above, the image PG4 is an example of this print preview image.

The control apparatus may also employ a configuration such that the information indicating permission or prohibition of ejection about at least one of the one or more types of color materials used for printing in accordance with the print job information includes a warning image warning that a combination of the color materials to be used for the printing in accordance with the print job information includes a color material to be ejected from a nozzle specified by the ejection permission/prohibition specification information as being prohibited from ejecting the color material. In the example described above, the image PG21 is an example of this warning image.

The control apparatus may also employ a configuration such that the information indicating permission or prohibition of ejection about at least one of one or more types of color materials to be used for printing in accordance with the print job information includes information suggesting correction of the print job information.

The control apparatus may also employ a configuration such that the print job information includes to-be-used color material information indicating one or more types of color materials to be used to print the image indicated by the image information, and based on the to-be-used color material information included in the print job information and the ejection permission/prohibition specification information received by the receiver, the display controller displays, on the display unit, the information indicating permission or prohibition of ejection about at least one of the one or more types of color materials to be used for the printing in accordance with the print job information when a combination of the one or more types of color materials indicated by the to-be-used color material information is not covered by a combination of color materials to be ejected from one or more ejection permitted nozzles that the ejection permission/prohibition specification information specifies as being permitted to eject the color material from among the one or more nozzles associated with the color material to eject.

The control apparatus may also employ a configuration such that the to-be-used color material information includes information indicating one or more types of color materials to be used for each raster of the image.

The control apparatus may also employ a configuration such that when an operation for starting printing in accordance with the print job information is received, the display controller determines whether the combination of the one or more types of color materials indicated by the to-be-used color material information is covered by the combination of color materials to be ejected from the one or more ejection permitted nozzles, and displays, on the display unit, the information indicating permission or prohibition of ejection about at least one of the one or more types of color materials to be used for the printing in accordance with the print job information when the combination of the one or more types of color materials indicated by the to-be-used color material information is not covered by the combination of color materials to be ejected from the one or more ejection permitted nozzles.

The control apparatus may also employ a configuration such that the display unit is integral with the printing apparatus.

The control apparatus may also employ a configuration such that the display is separate from the printing apparatus.

The control apparatus may also employ a configuration such that the control apparatus is included in the printing apparatus.

The control apparatus may also employ a configuration such that the control apparatus is separate from the printing apparatus.

Thus far, an embodiment of the present disclosure has been described in detail with reference to the drawings. However, specific configurations are not limited to those in this embodiment, and may be, e.g., modified, replaced, or deleted without departing from the gist of the present disclosure.

It is also possible to record, in a computer-readable recording medium, a program for implementing the functions of any components of the apparatus described above, load the program into a computer system, and execute the program. This apparatus is, for example, the printing apparatus 1 or the control apparatus 40. Note that the “computer system” here includes hardware such as an operating system (OS) and peripherals. In addition, the “computer-readable recording medium” is a portable medium such as a flexible disk, a magneto-optical disk, a ROM, or a compact disk (CD)-ROM or a storage device such as a hard disk drive incorporated in the computer system. Also, the “computer-readable recording medium” includes one that holds a program for a certain period of time, like a volatile memory (RAM) inside a computer system serving as a server or a client when the program is transmitted via a network such as the Internet or lines of communication such as telecommunication lines.

Also, the above-described program may be transmitted from the computer system having the program stored in a storage device or the like to another computer system via a transmission medium or by use of transmission waves inside the transmission medium. The “transmission medium” that transmits the program is a medium having the capability of information transmission, like a network (a communication network) such as the Internet or lines of communication (communication lines) such as telecommunication lines.

Also, the program may be for implementing some of the functions described above. In addition, the program may be what is called a differential file (a differential program), which can implement the above-described functions in combination with a program already recorded in the computer system.

What is claimed is:

1. A control apparatus that controls a printing apparatus having one or more nozzles associated with a color material to eject, the control apparatus comprising:
a receiver that receives ejection permission/prohibition specification information specifying, for each of the one or more nozzles, whether the nozzle is permitted to eject or prohibited from ejecting the color material; and
a display controller that displays, on a display unit, based on the ejection permission/prohibition specification information received by the receiver and print job information including image information indicating an image to be printed on a print medium, information indicating permission or prohibition of ejection about at least one of one or more types of color materials to be used for printing in accordance with the print job information.

2. The control apparatus according to claim 1, wherein
the information includes a print preview image of the image indicated by the image information.

3. The control apparatus according to claim 1, wherein
the information includes a warning image warning that a combination of color materials to be used for printing in accordance with the print job information includes a color material to be ejected from a nozzle specified by the ejection permission/prohibition specification information as being prohibited from ejecting the color material.

4. The control apparatus according to claim 1, wherein
the information includes information suggesting correction of the print job information.

5. The control apparatus according to claim 1, wherein
the print job information includes to-be-used color material information indicating one or more types of color materials to be used to print the image indicated by the image information, and
based on the to-be-used color material information included in the print job information and the ejection permission/prohibition specification information received by the receiver, the display controller displays the information on the display unit when a combination of the one or more types of color materials indicated by the to-be-used color material information is not covered by a combination of color materials to be ejected from ejection permitted nozzles that the ejection permission/prohibition specification information specifies as being permitted to eject the color material from among the one or more nozzles.

6. The control apparatus according to claim 5, wherein
the to-be-used color material information includes information indicating one or more types of color materials to be used for each raster of the image.

7. The control apparatus according to claim 5, wherein
when an operation for starting printing in accordance with the print job information is received, the display controller determines whether the combination of the one or more types of color materials indicated by the to-be-used color material information is covered by the combination of the color materials to be ejected from the ejection permitted nozzles, and displays the information on the display unit when the combination of the one or more types of color materials indicated by the to-be-used color material information is not covered by the combination of the color materials to be ejected from the ejection permitted nozzles.

8. The control apparatus according to claim 1, wherein
the display unit is integral with the printing apparatus.

9. The control apparatus according to claim 1, wherein
the display unit is separate from the printing apparatus.

10. The control apparatus according to claim 1, wherein
the control apparatus is included in the printing apparatus.

11. The control apparatus according to claim 1, wherein
the control apparatus is separate from the printing apparatus.

12. A control method for controlling a printing apparatus having one or more nozzles associated with a color material to eject, the control method comprising:
a receiving step of receiving ejection permission/prohibition specification information specifying, for each of the one or more nozzles, whether the nozzle is permitted to eject or prohibited from ejecting the color material; and
a displaying step of displaying, on a display unit, based on the ejection permission/prohibition specification information received in the receiving step and print job information including image information indicating an image to be printed on a print medium, information indicating permission or prohibition of ejection about at least one of one or more types of color materials to be used for printing in accordance with the print job information.

13. A non-transitory computer-readable storage medium storing a program for causing a computer that controls a printing apparatus having one or more nozzles associated with a color material to eject to execute processing comprising:
a receiving step of receiving ejection permission/prohibition specification information specifying, for each of the one or more nozzles, whether the nozzle is permitted to eject or prohibited from ejecting the color material; and
a displaying step of displaying, on a display unit, based on the ejection permission/prohibition specification information received in the receiving step and print job information including image information indicating an image to be printed on a print medium, information indicating permission or prohibition of ejection about at least one of one or more types of color materials to be used for printing in accordance with the print job information.
